(19) United States
(12) Patent Application Publication
(10) Pub. No.: US 2025/0249712 A1
(43) Pub. Date: Aug. 7, 2025

(54) TRAILER HITCH AND VEHICLE

(71) Applicant: Wuhan Citymons Sports Technology Co., LTD, Wuhan (CN)

(72) Inventors: Jun Chen, Wuhan (CN); Han Liu, Wuhan (CN); Xinchen Liu, Wuhan (CN); Wenxuan Lei, Wuhan (CN); Yang Liu, Wuhan (CN)

(21) Appl. No.: 18/751,113

(22) Filed: Jun. 21, 2024

(30) Foreign Application Priority Data
Feb. 7, 2024 (CN) 202410174866.8

(51) Int. Cl. B60D 1/24

(52) U.S. Cl. CPC B60D 1/241; B60D 1/249

(57) ABSTRACT

The present disclosure provides a trailer hitch and a vehicle, and relates to the technical field of automobile parts. The trailer hitch includes a trailer hitch, and a transmission assembly, a pin, and a locking pin arranged in the trailer hitch, wherein the pin and the locking pin separately cooperate with the transmission assembly to jointly extend out of the trailer hitch under actuation of the transmission assembly; the trailer hitch is configured to insert into a trailer hitch receiver tube; the pin is configured to insert into a pin hole on a sidewall of the receiver tube after extension; and the locking pin is configured to abut against an inner wall of the receiver tube after extension.

### RELATED APPLICATION

The present disclosure claims the priority to the Chinese patent application with the filing No. 202410174866.8 filed with the Chinese Patent Office on Feb. 7, 2024, and entitled “Trailer Hitch and Vehicle”, the contents of which are incorporated herein by reference in entirety.

It is intended that the above-referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure relates to the technical field of automobile parts, and specifically to a trailer hitch and a vehicle.

### BACKGROUND

With the development of economy and the progress of society, people's living standards continue to improve. The family passenger cars are becoming more and more popular, and trailers and recreational vehicles are gradually entering the public vision. More and more vehicles are begun to mount trailer traction devices, wherein connection devices are essential such as a trailer hitch.

The existing trailer hitch includes a quadrate tube, an arc plate, and a ball head, wherein the quadrate tube is a quadrate-shaped tube with a pin hole opened at the sidewall; the front end of the quadrate tube and the arc plate are connected to be a whole by welding; and the ball head is fixed on the arc plate by a nut. During use, the quadrate tube is partially inserted into a trailer hitch receiver tube mounted on a trailer. The pin hole on the sidewall of the quadrate tube is aligned with the hole on the sidewall of the trailer hitch receiver tube, and they are connected together by a pin. The ball head is partially exposed for connecting to the trailer.

In the prior art, the pin connecting the quadrate tube and the trailer hitch receiver tube is mounted by manual pulling and inserting. The pin is easily lost, which results in a connection failure, and the operation is cumbersome, which cannot meet the growing needs of people. Moreover, a sectional size of the quadrate tube is smaller than the sectional size of the trailer hitch receiver tube, so that the quadrate tube is easily inserted into the trailer hitch receiver tube. Therefore, a gap exists between the two after connection, which will cause vibrations and abnormal sounds when driving and affect the driving safety.

### BRIEF OVERVIEW

For the above deficiencies in the prior art, the present disclosure is to provide a trailer hitch and a vehicle, which can realize a reliable connection between the trailer hitch and the trailer hitch receiver tube and can eliminate a gap between the trailer hitch and the trailer hitch receiver tube, and the operation is simple and convenient.

In order to realize the above purposes, the embodiments of the present disclosure adopt the following technical solutions.

On the one hand, the embodiments of the present disclosure provide a trailer hitch, which includes: a trailer hitch, a transmission assembly, a pin, and a locking pin arranged in the trailer hitch, wherein the pin and the locking pin separately cooperate with the transmission assembly to jointly extend out of the trailer hitch under actuation of the transmission assembly; the trailer hitch is configured to insert into a trailer hitch receiver tube; the pin is configured to insert into a pin hole on a sidewall of the receiver tube after extension; and the locking pin is configured to abut against an inner wall of the receiver tube after extension.

Optionally, the transmission assembly includes a screw and a locking slider cooperating with the screw, wherein axes of the screw and the trailer hitch are parallel to each other; and the locking slider is provided with a linkage structure, wherein the linkage structure cooperates with the pin and the locking pin respectively, so as to convert movement of the locking slider in a first direction into movements of the pin and the locking pin in a second direction, wherein the second direction is perpendicular to the first direction.

Optionally, the linkage structure includes a guiding rod, wherein one end of the guiding rod is fixed to the locking slider and the other end extends into a guiding slot of the pin, and the locking slider drives the pin to move by the guiding rod.

Optionally, a sidewall of the guiding slot includes a flat sidewall and an inclined sidewall connected to the flat sidewall, and the guiding slot is also provided with a limit column, wherein the guiding rod is clamped between a sidewall of the guiding slot and the limit column; the guiding rod includes an inclined section, a first flat section and a second flat section separately connected to two opposite ends of the inclined section, wherein the inclined section is parallel to the inclined sidewall; the pin retracts into the trailer hitch when the first flat section is attached to the flat sidewall; and the pin extends out of the trailer hitch when the second flat section is attached to the flat sidewall.

Optionally, the linkage structure includes a first beveled surface arranged on the locking slider, and the locking pin is provided with a second beveled surface cooperating with the first beveled surface, wherein the locking slider pushes the locking pin to extend out by the first beveled surface.

Optionally, the locking pin is provided with an elastic plate, wherein the elastic plate abuts against an inner wall of the trailer hitch, and the elastic plate is configured to retract the locking pin into the trailer hitch.

Optionally, the linkage structure includes a first beveled surface arranged on the locking slider and a first plane connected to an end of the first beveled surface, and the locking pin is provided with a second beveled surface cooperating with the first beveled surface and a second plane cooperating with the first plane; the second plane cooperates with the first plane and the locking pin retracts into the trailer hitch when the first flat section is attached to the flat sidewall; and the second beveled surface cooperates with the first beveled surface and the locking pin extends out of the trailer hitch when the second flat section is attached to the flat sidewall.

Optionally, a handle assembly arranged on an outer wall of the trailer hitch is also included, wherein the handle assembly is in linkage with the screw, and the handle assembly is configured to drive the screw to rotate.

Optionally, the handle assembly includes a handle body and a transmission shaft connected to the handle body; and the transmission assembly further includes a locking shaft, a first bevel gear arranged on the locking shaft, and a second bevel gear cooperating with the first bevel gear, wherein the locking shaft and the transmission shaft are coaxially arranged and fixedly connected, and the second bevel gear and the screw are coaxially arranged and fixedly connected.

On the other hand, the embodiments of the present disclosure provide a vehicle including the trailer hitch according to any one as above mentioned.

The present disclosure includes the following beneficial effects.

The present disclosure provides a trailer hitch, which includes the trailer hitch, the transmission assembly, the pin, and the locking pin arranged in the trailer hitch, wherein the pin and the locking pin separately cooperate with the transmission assembly to jointly extend out of the trailer hitch under actuation of the transmission assembly; the trailer hitch is configured to insert into the trailer hitch receiver tube; the pin is configured to insert into a pin hole on a sidewall of the receiver tube after extension; and the locking pin is configured to abut against the inner wall of the receiver tube after extension. The trailer hitch is provided with the transmission assembly, and the pin, and the locking pin cooperating with the transmission assembly in the trailer hitch, wherein the pin can be in linkage with the locking pin by the transmission assembly, and the transmission assembly can drive the pin and the locking pin simultaneously, so that the pin and the locking pin jointly extend out of the trailer hitch. The trailer hitch on the one hand can realize a reliable connection between the trailer hitch and the trailer hitch receiver tube and on the other hand can eliminate a gap between the trailer hitch and the trailer hitch receiver tube, and the operation is simple and convenient.

### BRIEF DESCRIPTION OF THE DRAWINGS

In order to more clearly illustrate the technical solutions of the embodiments of the present disclosure, the drawings to be used in the embodiments will be briefly introduced below. It should be understood that the following drawings only show certain embodiments of the present disclosure, and therefore should not be regarded as a limitation of the scope. For a person of ordinary skill in the art, other relevant drawings can be obtained from these drawings without inventive efforts.

FIG. 1 shows a schematic diagram of an internal structure of a trailer hitch provided by the embodiments of the present disclosure;

FIG. 2 shows a schematic structure diagram of a trailer hitch provided by the embodiments of the present disclosure;

FIG. 3 shows an explosion diagram of a transmission assembly, a pin, and a locking pin in a trailer hitch provided by the embodiments of the present disclosure;

FIG. 4 shows a matching schematic diagram of a guiding rod and a guiding slot when a pin in a trailer hitch is in a retraction state provided by the embodiments of the present disclosure;

FIG. 5 shows a matching schematic diagram of a guiding rod and a guiding slot when a pin in a trailer hitch is in an extending state provided by the embodiments of the present disclosure;

FIG. 6 shows the other matching schematic diagram of a guiding rod and a guiding slot when a pin in a trailer hitch is in an extending state provided by the embodiments of the present disclosure;

FIG. 7 shows a matching schematic diagram of a locking slider and a locking pin when a locking pin in a trailer hitch is in a retraction state provided by the embodiments of the present disclosure;

FIG. 8 shows a matching schematic diagram of a locking slider and a locking pin when a locking pin in a trailer hitch is in an extending state provided by the embodiments of the present disclosure; and

FIG. 9 shows the other matching schematic diagram of a locking slider and a locking pin when a locking pin in a trailer hitch is in a retraction state provided by the embodiments of the present disclosure.

Reference numbers: 10—trailer hitch; 11—trailer hitch; 12—transmission assembly; 121—screw; 122—locking slider; 1221—first beveled surface; 1222—first plane; 123—guiding rod; 1231—inclined section; 1232—first flat section; 1233—second flat section; 124—locking shaft; 125—first bevel gear; 126—second bevel gear; 127—pin holder; 13—pin; 131—guiding slot; 1311—flat sidewall; 1312—inclined sidewall; 132—limit column; 14—locking pin; 141—second beveled surface; 142—second plane; 143—elastic plate; 15—handle assembly; 151—handle body; and 152—transmission shaft.

### DETAILED DESCRIPTION

In order to make the purpose, technical solutions, and advantages of the embodiments of the present disclosure clearer, the technical solutions in the embodiments of the present disclosure will be described clearly and completely below in conjunction with the drawings in the embodiments of the present disclosure. It is clear that the described embodiments are partial embodiments of the present disclosure, and not all embodiments. The components of embodiments of the present disclosure generally described and illustrated in the drawings herein can be arranged and designed in a variety of different configurations.

Therefore, the following detailed description of embodiments of the present disclosure provided in the drawings is not intended to limit the scope of the present disclosure for which protection is claimed, but only represents selected embodiments of the present disclosure. It is to be noted that the various features in the embodiments of the present disclosure can be combined with each other without conflict, and the combined embodiments are still within the scope of protection of the present disclosure.

It should be noted: similar symbols and letters denote similar items in the following drawings. Therefore, once an item is defined in a drawing, it does not need to be further defined in the subsequent drawings.

In the description of the present disclosure, it should be noted that the terms indicating orientations or positional relationships, such as “center”, “up”, “down”, “left”, “right”, “vertical”, “horizontal”, “inside”, “outside”, etc., are the orientations or positional relationships based on the drawings, or the orientations or positional relationships that the product of the present disclosure is customarily placed in use, and are intended only to facilitate the description of the present disclosure and simplify the description, and are not indicating or implying that the device or element referred to must have a particular orientation, be constructed and operate in a particular orientation, and therefor are not to be understood as limitations of the present disclosure. Furthermore, the terms “first”, “second”, “third”, etc., are used for descriptive purposes only, and are not to be understood as indicating or implying relative importance.

In the description of the present disclosure, it should also be noted, unless otherwise expressly specified and limited, the terms “provide”, “mount”, “connect”, and “link” are to be understood in a broad sense, for example, it can be a fixed connection, a detachable connection, or an integral connection; a mechanical connection, or an electrical connection; and a direct connection, an indirect connection through an intermediate medium, or a communication inside two elements. For a person of ordinary skill in the art, the specific meaning of the above terms in the present disclosure can be understood in specific cases.

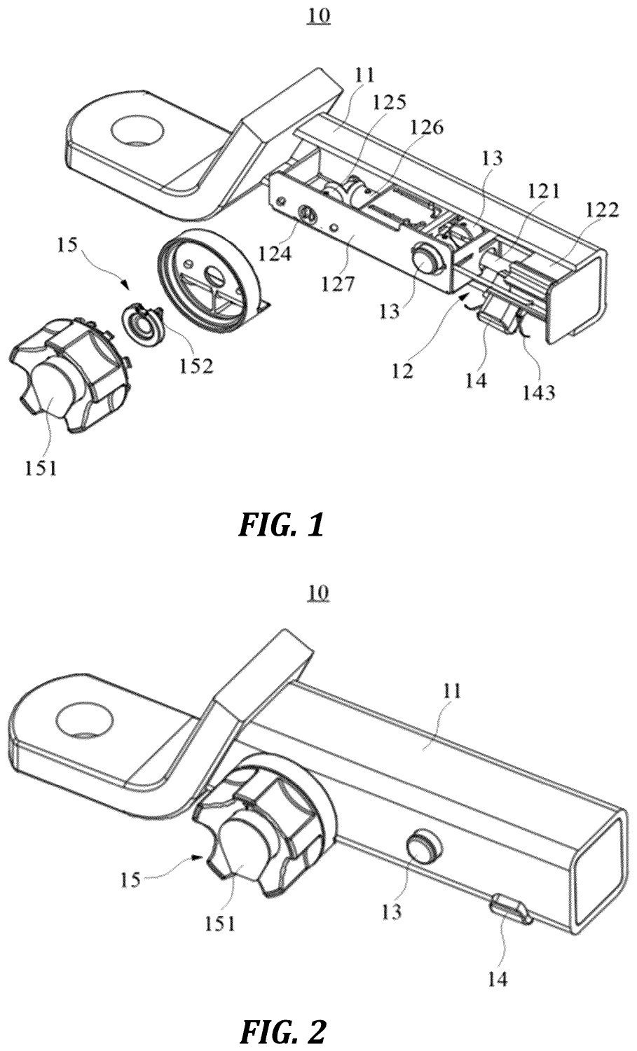

On the one hand, referring to FIG. 1 and FIG. 2, the embodiments of the present disclosure provide a trailer hitch 10, which includes a trailer hitch 11, a transmission assembly 12, and a pin 13, and a locking pin 14 arranged the trailer hitch 11, wherein the pin 13 and the locking pin 14 separately cooperate with the transmission assembly 12 to jointly extend out of the trailer hitch 11 under actuation of the transmission assembly 12; the trailer hitch 11 is configured to insert into a trailer hitch receiver tube; the pin 13 is configured to insert into a pin hole on a sidewall of the receiver tube after extension; and the locking pin 14 is configured to abut against an inner wall of the receiver tube after extension.

The trailer hitch 11 is configured to insert into the trailer hitch receiver tube, and a shape of the outer wall of the trailer hitch 11 is adapted to a shape of the inner wall of the trailer hitch receiver tube. Generally, the trailer hitch 11 is a quadrate tube, and the trailer hitch receiver tube is a quadrate-shaped tube. The transmission assembly 12, the pin 13, and the locking pin 14 are arranged in the trailer hitch 11, and the sidewall of the trailer hitch 11 is provided with through holes separately corresponding to positions of the pin 13 and the locking pin 14. The sidewall of the trailer hitch receiver tube is provided with a pin hole corresponding to the position of the pin 13. The pin 13 is driven by the transmission assembly 12 and extends out of the trailer hitch 11 through a corresponding through hole, and then extends into the pin hole of the trailer hitch receiver tube to realize a reliable connection between the trailer hitch 11 and the trailer hitch receiver tube. The locking pin 14 is driven by the transmission assembly 12 and extends out of the trailer hitch 11 through a corresponding through hole, and then abuts against the inner wall of the trailer hitch receiver tube, so as to eliminate a gap between the trailer hitch 11 and the trailer hitch receiver tube, thereby reducing vibrations and abnormal sounds, and improving driving safety.

It should be noted that in the embodiment, the structure of the transmission assembly 12 is not limited, as long as it can cooperate with the pin 13 and the locking pin 14 simultaneously, and can drive the pin 13 and the locking pin 14 to extend out of the trailer hitch 11 together. Additionally, the pin 13 and the locking pin 14 extending out of the trailer hitch 11 together does not mean that the pin 13 and the locking pin 14 must extend out of the trailer hitch 11 simultaneously, and can be that the pin 13 and the locking pin 14 separately extend out of the trailer hitch 11 one after the other. The drive method of the transmission assembly 12 can be manually driven, or other drive assemblies can be provided to drive thereof, which is similarly not limited by the present embodiment.

The foregoing trailer hitch 10 is provided with the transmission assembly 12, and the pin 13 and the locking pin 14 cooperating with the transmission assembly 12 in the trailer hitch 11, wherein the pin 13 cooperates with the locking pin 14 by the transmission assembly 12, and the transmission assembly 12 can drive the pin 13 and the locking pin 14 to move simultaneously, so that the pin 13 and the locking pin 14 jointly extend out of the trailer hitch 11. The foregoing trailer hitch 10 on the one hand can realize the reliable connection between the trailer hitch 11 and the trailer hitch receiver tube and on the other hand can eliminate the gap between the trailer hitch 11 and the trailer hitch receiver tube, and the operation is simple and convenient.

Optionally, in a realizable method of the embodiments of the present disclosure, the transmission assembly 12 includes a screw 121 and a locking slider 122 cooperating with the screw 121, wherein axes of the screw 121 and the trailer hitch 11 are parallel to each other; and the locking slider 122 is provided with a linkage structure, wherein the linkage structure cooperates with the pin 13 and the locking pin 14 respectively, so as to convert movement of the locking slider 122 in a first direction into movements of the pin 13 and the locking pin 14 in a second direction, wherein the second direction is perpendicular to the first direction.

The axial dimension of the trailer hitch 11 is larger than the radial dimension, and therefore the transmission assembly 12 is arranged mainly by using the axial space of the trailer hitch 11. The screw 121 is arranged in the trailer hitch 11, and the locking slider 122 is sleeved on the screw 121, wherein the locking slider 122 cooperates with the screw 121 through screw threads. The screw 121 is driven to rotate, so that the locking slider 122 can be driven to reciprocate along the axial direction (i.e., the first direction) of the trailer hitch 11. Since the trailer hitch receiver tube is located outside the radial direction of the trailer hitch 11, the locking slider 122 is further provided with the linkage structure. The linkage structure separately cooperates with the pin 13 and the locking pin 14, so as to convert the movement of the locking slider 122 in the first direction into the movements of the pin 13 and the locking pin 14 in the second direction (i.e., the radical direction of the trailer hitch 11).

In the embodiment, the linkage structure is similarly not limited. The linkage structure can be a part of the locking slider 122, i.e., it is a structural feature of a partial region of the locking slider 122, or can be a separate component arranged on the locking slider 122, as long as the linkage structure can convert the movement of the locking slider 122 in the first direction into the movements of the pin 13 and the locking pin 14 in the second direction.

Exemplarily, two pins 13 are provided, wherein the two pins are symmetrically arranged on two sides of the screw 121, and the two pins 13 are driven by the locking slider 122 to simultaneously extend out of the trailer hitch 11 and insert into the pin holes on the sidewall of the receiver tube. The two pins 13 are provided to further improve the reliability of the connection between the trailer hitch 11 and the trailer hitch receiver tube.

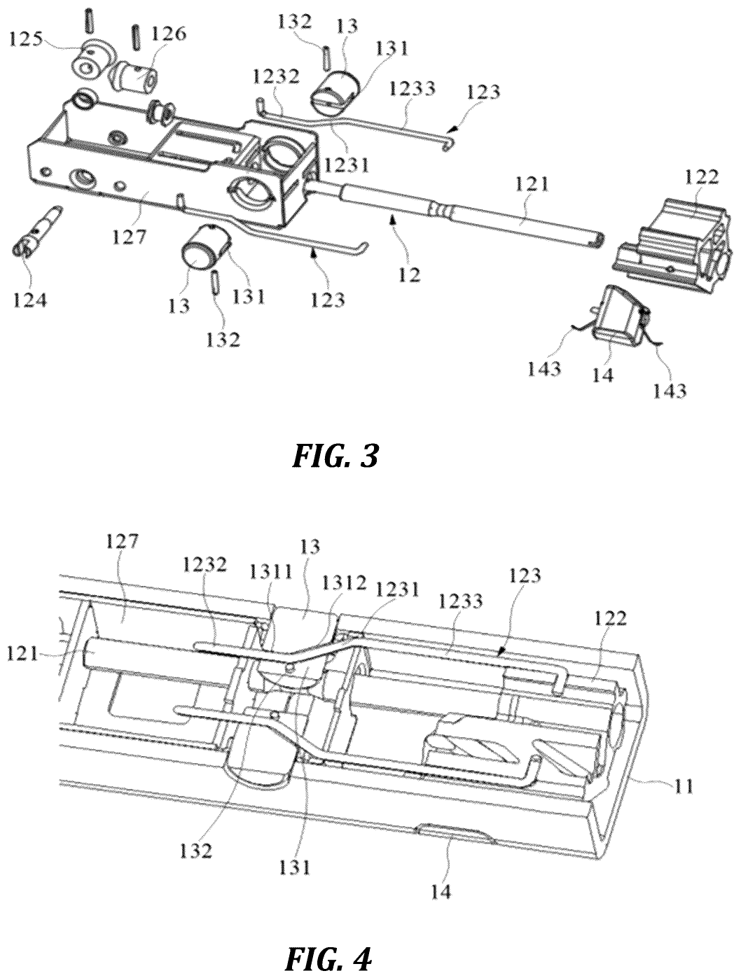

Optionally, in a realizable method of the embodiments of the present disclosure, referring to FIG. 3 and FIG. 4, the linkage structure includes a guiding rod 123, wherein one end of the guiding rod 123 is fixed to the locking slider 122 and the other end extends into the guiding slot 131 of the pin 13, and the locking slider 122 drives the pin 13 to move by the guiding rod 123.

In the embodiment, the linkage structure is the separate component arranged on the locking slider 122, i.e., the guiding rod 123, and the locking slider 122 drives the pin 13 to move in the second direction by the guiding rod 123. The locking slider 122 can cooperate directly with the locking pin 14, or it can cooperate with the locking pin 14 by other separate components. The guiding rod 123 is provided to draw apart the pin 13 from the locking pin 14 for a certain distance, thereby avoiding mutual interference between them.

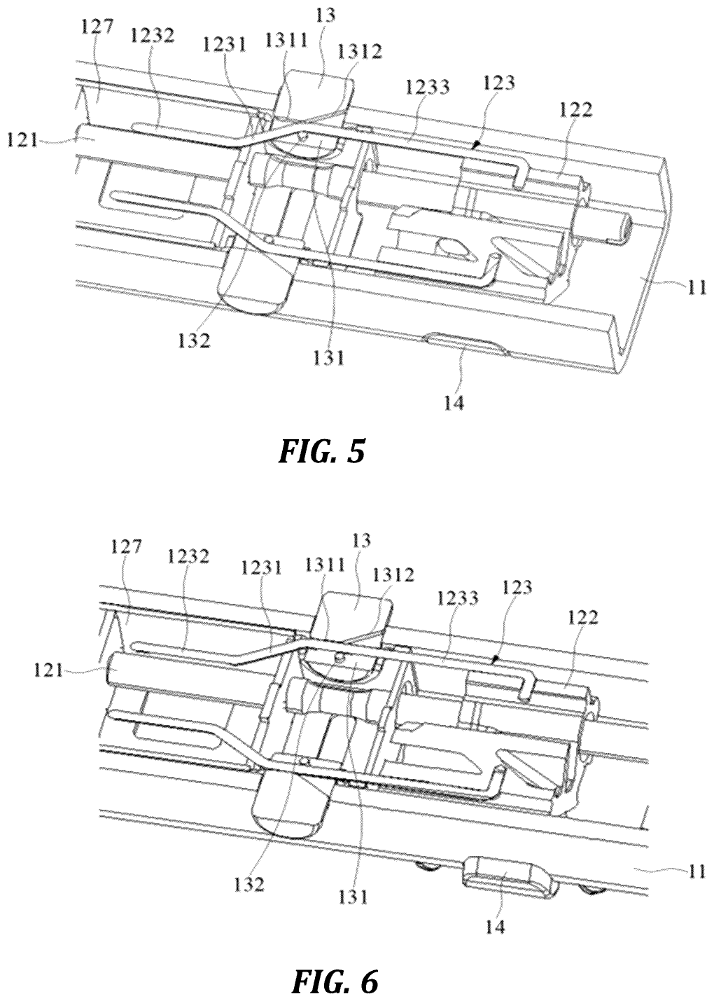

Optionally, in a realizable method of the embodiments of the present disclosure, referring in conjunction to FIG. 5 and FIG. 6, a sidewall of the guiding slot 131 includes a flat sidewall 1311 and an inclined sidewall 1312 connected to the flat sidewall 1311, and the guiding slot 131 is further provided therein with a limit column 132, wherein the guiding rod 123 is clamped between the sidewall of the guiding slot 131 and the limit column 132. The guiding rod 123 includes an inclined section 1231, and a first flat section 1232 and a second flat section 1233 separately connected to two opposite ends of the inclined section 1231, wherein the inclined section 1231 is parallel to the inclined sidewall 1312, and a length of the inclined section 1231 is not shorter than a length of the inclined sidewall 1312, so as to be attached to the inclined sidewall 1312.

As shown in FIG. 4, when the first flat section 1232 of the guiding rod 123 is attached to the flat sidewall 1311 of the guiding slot 131, the pin 13 is retracted into the trailer hitch 11. The locking slider 122 drives the guiding rod 123 to move. As shown in FIG. 5, when the first flat section 1232 of the guiding rod 123 is separated from the flat sidewall 1311 of the guiding slot 131, and when the inclined section 1231 of the guiding rod 123 is attached to the inclined sidewall 1312 of the guiding slot 131, the pin 13 gradually extends out of the trailer hitch 11. The locking slider 122 continues to drive the guiding rod 123 to move, as shown in FIG. 6, when the inclined section 1231 of the guiding rod 123 moves to be separated from the inclined sidewall 1312 of the guiding slot 131, the second flat section 1233 of the guiding rod 123 is attached to the flat sidewall 1311 of the guiding slot 131, and the pin 13 remains on the extension position.

When the screw 121 is reversed and the locking slider 122 drives the guiding rod 123 to move towards an opposite direction, the pin 13 changes to the retraction state from the extending state. The process has the same principle as the principle that the pin 13 changes from the retraction state to the extending state, and will not be described herein by the embodiment.

The above structures of the guiding slot 131 and the guiding rod 123 can convert the movement of the locking slider 122 in the first direction into the movement of the pin 13 in the second direction, and the pin 13 can be controlled to extend or retract by forward and reverse rotation of the screw 121, which is simple in structure and easy to control.

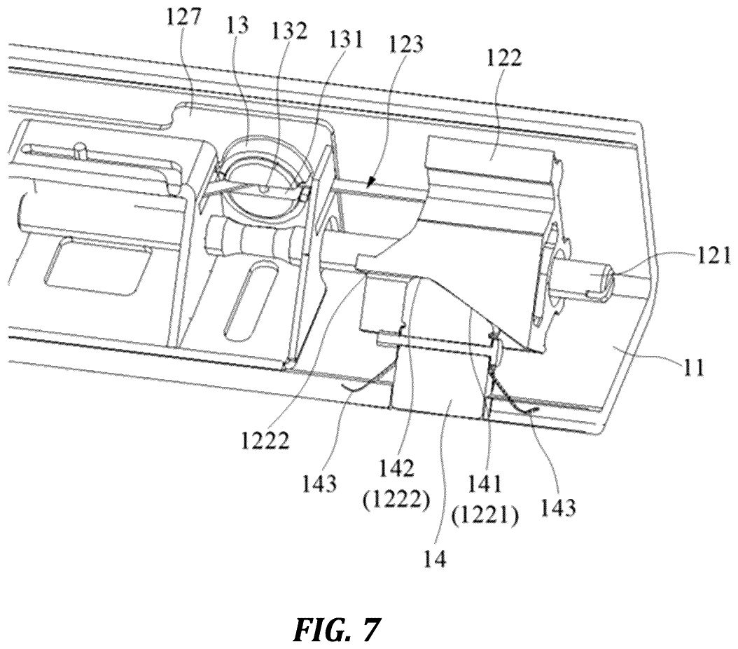

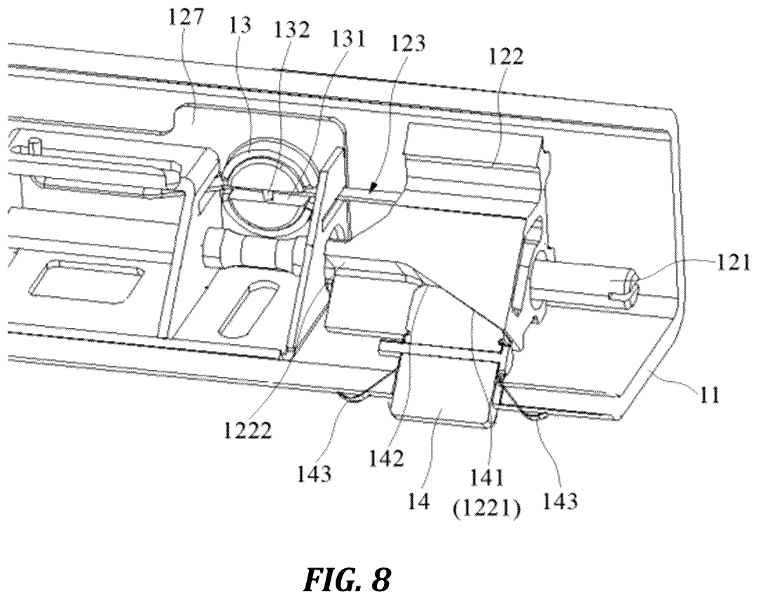

Optionally, in a realizable method of the embodiments of the present disclosure, referring to FIG. 7 and FIG. 8, the linkage structure includes a first beveled surface 1221 arranged on the locking slider 122, and the locking pin 14 is provided with a second beveled surface 141 cooperating with the first beveled surface 1221, wherein the locking slider 122 pushes the locking pin 14 to extend out by the first beveled surface 1221.

In the embodiment, the linkage structure is the structural feature of the partial region of the locking slider 122, at which point the locking slider 122 directly cooperates with the locking pin 14 by a beveled surface. The first beveled surface 1221 and the second beveled surface 141 can attach to each other, and the first beveled surface 1221 is arranged at an acute angle to the axis of the screw 121. When the first beveled surface 1221 is attached to the second beveled surface 141, the locking slider 122 moves in the first direction to push the locking pin 14 to extend out in the second direction.

It can be understood that when the locking slider 122 moves in a certain direction, the arrangement of the inclination direction of the first beveled surface 1221 on the locking slider 122 and the inclination direction of the inclined section 1231 on the guiding rod 123 shall ensure that the locking pin 14 and the pin 13 can be driven to jointly extend out of the trailer hitch 11.

Optionally, in a realizable method of the embodiments of the present disclosure, the locking pin 14 is provided with an elastic plate 143, wherein the elastic plate 143 abuts against an inner wall of the trailer hitch 11, and the elastic plate 143 is configured to retract the locking pin 14 into the trailer hitch 11.

As shown in FIG. 7, when the locking pin 14 is in the retraction state, the elastic plates 143 are in the natural state, and the ends of the elastic plate 143 abut against the inner wall of the trailer hitch 11. As shown in FIG. 8, when the locking pin 14 is driven by the locking slider 122 to gradually extend out of the trailer hitch 11, the elastic plates 143 deform under pressure and store energy, at which point the locking slider 122 exerts a pressure on the locking pin 14, so that the locking pin 14 remains the extending state. After the screw 121 is reversed and the locking slider 122 moves in the opposite direction to relieve the pressure exerted on the locking pin 14, the elastic plates 143 are restored to drive the locking pin 14 to retract into the trailer hitch 11 to realize reset.

Exemplarily, two elastic plates 143 are provided, and the two elastic plate 143 are symmetrically arranged on two sides of the locking pin 14. The two elastic plate 143 simultaneously abut against the inner wall of the trailer hitch 11, so that the force applied on the locking pin 14 is more balanced, which avoids the locking pin 14 from tilting of attitude due to the uneven pressure during the process of retraction.

Optionally, in a realizable method of the embodiments of the present disclosure, the linkage structure includes the first beveled surface 1221 arranged on the locking slider 122 and a first plane 1222 connected to an end of the first beveled surface 1221, and the locking pin 14 is provided with the second beveled surface 141 cooperating with the first beveled surface 1221 and a second plane 142 cooperating with the first plane 1222.

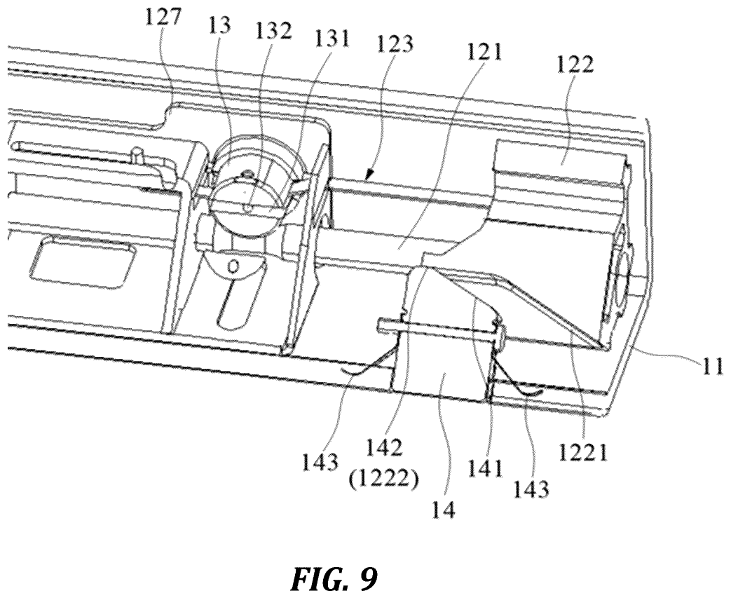

As shown in FIG. 4 and FIG. 9, when the first flat section 1232 of the guiding rod 123 is attached to the flat sidewall 1311 of the guiding slot 131, the pin 13 is retracted into the trailer hitch 11. Since the second plane 142 of the locking pin 14 cooperates with the first plane 1222 of the locking slider 122, the locking pin 14 is also retracted into the trailer hitch 11. Referring to FIG. 5, the locking slider 122 drives the guiding rod 123 to move, so as to drive the pin 13 to gradually extend out. The second plane 142 of the locking pin 14 moves relative to the first plane 1222 of the locking slider 122 and they still maintain a cooperating relationship. Referring to FIG. 7, when an intersection point of the inclined section 1231 and the second flat section 1233 of the guiding rod 123 coincides with a junction of the flat sidewall 1311 and the inclined sidewall 1312 of the guiding slot 131, an intersection point of the second plane 142 and the second beveled surface 141 of the locking pin 14 coincides with an intersection point of the first plane 1222 and the first beveled surface 1221 of the locking slider 122. At this time, the pin 13 extends out of the trailer hitch 11. The locking pin 14 is still in the retraction state, but is about to extend out of the trailer hitch 11. The locking slider 122 continues to drive the guiding rod 123 to move. As shown in FIG. 6 and FIG. 8, when the second flat section 1233 of the guiding rod 123 is attached to the flat sidewall 1311 of the guiding slot 131, the pin 13 remains on the extension position. Meanwhile, the second beveled surface 141 of the locking pin 14 cooperates with the first beveled surface 1221 of the locking slider 122, and the locking pin 14 extends out of the trailer hitch 11.

In the embodiment, the trailer hitch 10 can realize three states in sequence during the process of the locking slider 122 moving towards a certain direction: the first state is that the pin 13 and the locking pin 14 both are in the retraction state; the second state is that the pin 13 is in the extending state and the locking pin 14 is in the retraction state; and the third state is that the pin 13 and the locking pin 14 both are in the extending state. That is to say, the pin 13 and the locking pin 14 do not simultaneously extend out of the trailer hitch 11 although they have a linkage relationship. The function of the trailer hitch 10 is realized by two steps: the first step is firstly to realize the extension of the pin 13, so as to realize the reliable connection between the trailer hitch 11 and the trailer hitch receiver tube; and then the second step is to realize the extension of the locking pin 14, so as to eliminate the gap between the trailer hitch 11 and the trailer hitch receiver tube.

Optionally, in a realizable method of the embodiments of the present disclosure, referring to FIG. 1 and FIG. 2, the trailer hitch 10 further includes a handle assembly 15 arranged on the outer wall of the trailer hitch 11, wherein the handle assembly 15 is in linkage with the screw 121, and the handle assembly 15 is configured to drive the screw 121 to rotate.

By rotating the handle assembly 15 outside the trailer hitch 11, the user can drive the screw 121 inside the trailer hitch 11 to rotate, so as to control the pin 13 and locking pin 14 to extend. In the embodiment, the structure of the handle assembly 15 is not limited, as long as the user can drive the screw 121 to rotate forwardly and reversely outside the trailer hitch 11. Additionally, the handle assembly 15 and the screw 121 can be connected directly, or can be connected indirectly by other components, as long as they can realize linkage with each other.

Optionally, in a realizable method of the embodiments of the present disclosure, the handle assembly 15 includes a handle body 151 and a transmission shaft 152 connected to the handle body 151; and the transmission assembly 12 further includes a locking shaft 124, a first bevel gear 125 arranged on the locking shaft 124, and a second bevel gear 126 cooperating with the first bevel gear 125, wherein the locking shaft 124 and the transmission shaft 152 are coaxially arranged and fixedly connected, and the second bevel gear 126 and the screw 121 are coaxially arranged and fixedly connected.

The user rotates the handle body 151 to drive the transmission shaft 152 to rotate, and the transmission shaft 152 transmits the rotating force to the locking shaft 124. The direction of the rotating force is changed by the first bevel gear 125 and the second bevel gear 126, and the rotating force is transmitted to the screw 121, so that the locking slider 122 is driven to move back and forth in the axial direction (the first direction) of the trailer hitch 11.

Optionally, in a realizable method of the embodiments of the present disclosure, the transmission assembly 12 further includes a pin holder 127, wherein the pin holder 127 is fixed in the trailer hitch 11. The pin 13 is slidably arranged on a sidewall of the pin holder 127, so that the pin holder 127 guides the movement of the pin 13.

Furthermore, the locking shaft 124, the first bevel gear 125, the second bevel gear 126, and the screw 121 are rotationally arranged in the pin holder 127, wherein the pin holder 127 supports the locking shaft 124 and the screw 121; the end of the screw 121 extends out of the pin holder 127 and cooperates with the locking slider 122; and the locking slider 122 and the locking pin 14 are located on the side of the pin holder 127.

The embodiment further provides a vehicle, including the trailer hitch 10 according to any one of the above.

The vehicle includes the same structures and beneficial effects as the trailer hitch 10 in the foregoing embodiments. The structures and beneficial effects of the trailer hitch 10 are described in detail in the foregoing embodiments, and will not be repeated herein.

The foregoing is merely preferred embodiments of the present disclosure and is not intended to limit the present disclosure. For those skilled in the art, the present disclosure may have various changes and variations. Any modifications, equivalent substitutions, improvements, etc. made within the spirit and principles of the present disclosure, shall be included in the scope of protection of the present disclosure.

What is claimed is:

1. A trailer hitch, comprising: a trailer hitch, and a transmission assembly, a pin, and a locking pin arranged in the trailer hitch, wherein the pin and the locking pin separately cooperate with the transmission assembly to jointly extend out of the trailer hitch under actuation of the transmission assembly; the trailer hitch is configured to insert into a trailer hitch receiver tube; the pin is configured to insert into a pin hole on a sidewall of the receiver tube after extension; and the locking pin is configured to abut against an inner wall of the receiver tube after extension.

2. The trailer hitch according to claim 1, wherein the transmission assembly comprises a screw and a locking slider cooperating with the screw, wherein axes of the screw and the trailer hitch are parallel to each other; and the locking slider is provided with a linkage structure, wherein the linkage structure cooperates with the pin and the locking pin respectively, so as to convert movement of the locking slider in a first direction into movements of the pin and the locking pin in a second direction, wherein the second direction is perpendicular to the first direction.

3. The trailer hitch according to claim 2, wherein the linkage structure comprises a guiding rod, wherein one end of the guiding rod is fixed to the locking slider and the other end extends into a guiding slot of the pin, and the locking slider drives the pin to move by the guiding rod.

4. The trailer hitch according to claim 3, wherein a sidewall of the guiding slot comprises a flat sidewall and an inclined sidewall connected to the flat sidewall, and the guiding slot is further provided with a limit column, wherein the guiding rod is clamped between the sidewall of the guiding slot and the limit column;
the guiding rod comprises an inclined section, and a first flat section and a second flat section separately connected to two opposite ends of the inclined section, wherein the inclined section is parallel to the inclined sidewall; and
the pin retracts into the trailer hitch when the first flat section is attached to the flat sidewall; and the pin extends out of the trailer hitch when the second flat section is attached to the flat sidewall.

5. The trailer hitch according to claim 2, wherein the linkage structure comprises a first beveled surface arranged on the locking slider, and the locking pin is provided with a second beveled surface cooperating with the first beveled surface, wherein the locking slider pushes the locking pin to extend out by the first beveled surface.

6. The trailer hitch according to claim 5, wherein the locking pin is provided with an elastic plate, wherein the elastic plate abuts against an inner wall of the trailer hitch, and the elastic plate is configured to retract the locking pin into the trailer hitch.

7. The trailer hitch according to claim 4, wherein the linkage structure comprises a first beveled surface arranged on the locking slider and a first plane connected to an end of the first beveled surface, and the locking pin is provided with a second beveled surface cooperating with the first beveled surface and a second plane cooperating with the first plane; and
the second plane cooperates with the first plane and the locking pin retracts into the trailer hitch when the first flat section is attached to the flat sidewall; and the second beveled surface cooperates with the first beveled surface and the locking pin extends out of the trailer hitch when the second flat section is attached to the flat sidewall.

8. The trailer hitch according to claim 2, further comprising a handle assembly arranged on an outer wall of the trailer hitch, wherein the handle assembly is in linkage with the screw, and the handle assembly is configured to drive the screw to rotate.

9. The trailer hitch according to claim 8, wherein the handle assembly comprises a handle body and a transmission shaft connected to the handle body; and the transmission assembly further comprises a locking shaft, a first bevel gear arranged on the locking shaft, and a second bevel gear cooperating with the first bevel gear, wherein the locking shaft and the transmission shaft are coaxially arranged and fixedly connected, and the second bevel gear and the screw are coaxially arranged and fixedly connected.

10. A vehicle, comprising the trailer hitch according to claim 1.
